(19) United States
(12) Patent Application Publication
(10) Pub. No.: US 2022/0066236 A1
(43) Pub. Date: Mar. 3, 2022

(54) THERMOCHROMIC CONTACT LENS

(71) Applicant: Kathryn Somosky, Old Saybrook, CT (US)

(72) Inventor: Kathryn Somosky, Old Saybrook, CT (US)

(21) Appl. No.: 17/465,764

(22) Filed: Sep. 2, 2021

Related U.S. Application Data
(60) Provisional application No. 63/073,693, filed on Sep. 2, 2020.

(51) Int. Cl. G02C 7/02; G02C 7/04; G02F 1/01

(52) U.S. Cl. CPC G02C 7/021; G02F 1/0147; G02C 7/04

(57) ABSTRACT

A contact lens is shown with patterns of thermochromic coating over the lens. The thermochromic coating is designed to change from colored to clear at just below body temperature in a human ocular surface or about 90 degrees Fahrenheit. As the lens cools in the ambient environment outside the eye, the thermochromic coating changes from clear to colored. The pattern is designed to provide contrasting colors when the contact lens is removed from the eye.

### CROSS-REFERENCE TO RELATED APPLICATIONS

This claims one or more inventions which were disclosed in Provisional Application No. 63/073,693 filed Sep. 2, 2020, entitled “THERMOCHROMIC CONTACT LENS”. The benefit under 35 USC § 119(e) of the United States provisional application is hereby claimed, and the aforementioned application is hereby incorporated herein by reference.

### BACKGROUND

The present invention relates to contact lenses, and more specifically to contact lenses coated with a thermochromic pigment that changes color w % ben removed from the eye.

Contacts have been used that will darken with sunlight (transition lenses) and include photochromic pigments that darken in response to an increase in UV light. The ACUVUE OASYS is a soft hydrophilic contact lens (senofilcon A) with photochromic additive which was approved by the FDA (See 510(k) Premarket Notification ACUVUE® (senofilcon A) Soft Contact Lens with Photochromic Additive by Johnson & Johnson Vision Care, Inc.—K180299)

The Johnson & Johnson Vision Care, Inc. device is a soft (hydrophilic) contact lens available in a spherical, toric, multifocal and/or multifocal-toric design. The composition of the lens is 62% senofilcon A and 38% water by weight when hydrated and stored in the buffered saline solution with methyl ether cellulose. The lens is supplied sterile (steam) in a foil sealed plastic package. The lenses are hemispherical or hemitoric shells. The device is made of a silicone hydrogel material containing an internal wetting agent and UV absorbing monomers. A combination of a benzotriazole UV absorbing monomer and a naphthopyran monomer (photochromic additive) is used to block UV radiation and dynamically absorbs visible light. The transmittance characteristics for these lenses are less than 1.0% in the UVB range of 280 nm to 315 nm and less than 10.0% in the UVA range of 316 nm to 380 nm for the entire power range. Additionally, the photochromic additive absorbs visible light in the range from 380 nm to 780 nm to a minimum 84% transmittance in the inactivated (closed) state. The activated (open) state dynamically absorbs visible light dependent on the lens thickness and the level of UV and high energy visible (HEV) radiation to a minimum of 23% transmittance.

Photochromism is a property of certain classes of molecules in which visible or ultraviolet light leads to the reversible isomerization of the molecule to another form having a different UV-visible absorption spectrum. Compounds of this type have found widespread use in sunlight-responsive optical articles, such as ophthalmic lenses, goggles, face shields, windows, aircraft transparencies, and display screens. Photochromic molecules can be loosely divided into two types: those that return to their initial state at a rate dependent on the ambient temperature (“thermally reversible” photochromic materials), and those which are thermally stable, requiring light absorption of a different wavelength to return to their initial state.

The specific intent of the Johnson & Johnson Vision Care, Inc. device is to mitigate this temperature dependence color change to emphasize the photochromic aspects of the device.

### SUMMARY

The present invention includes a contact lens that changes color when it is outside of the eye. A contact lens is embedded with thermochromic pigments that change color when there is a change in temperature. The lens will change color as a response to a change in atmosphere; specifically, temperature as opposed to light. While the lens remains in the eye, it is clear, and when it is outside of the eye and the ambient temperature is lower than body temperature of a user, the temperature change causes it to turn to a specific color. By embedding the lens with thermochromic ink, contact lenses can be more easily found when they fall out of one's eye.

The change in color is not dependent on sunlight, but rather is dependent on changes in temperature. Right now, if someone drops a clear lens, they are very difficult to find once out of the eye. The present invention allows a contact lens wearer to use clear lenses while inserted in the eye, but provides a contrasting color shift when the lens is in an environment below the wearer's or user's body temperature.

The thermochromic ink interacts with temperature; remaining colorless at approximately 98 degrees Fahrenheit and changing color when the temperature drops below normal body temperature of the user or wearer. The thermochromic ink can be embedded into any type of contact lens. The ink will remain clear within a few degrees of body temperature but will change color when the temperature falls below approximately 90 degrees F.

The change in temperature will trigger the ink to change from clear to a color, thereby making the lens easy to find when it is out of the eye. Different colors of ink can be utilized so that the user can pick what color is easy for them to identify.

While primarily described with a lens that shifts from clear to a color, the present invention could extend to colored lenses, if someone wanted a blue lens, then it could change to more contrasting color out of the eye.

### BRIEF DESCRIPTION OF THE DRAWINGS

FIG. 1 shows a contact lens with patterns of thermochromic coating over the lens.

### DETAILED DESCRIPTION

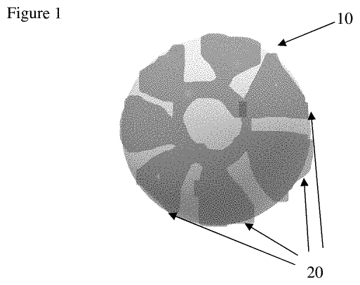

Referring to FIG. 1, a contact lens 10 is shown with patterns of thermochromic coating 20 over the lens. The thermochromic coating 20 is designed to change from colored to clear at just below body temperature in a human ocular surface or about 90 degrees Fahrenheit. As the lens cools in the ambient environment outside the eye, the thermochromic coating 20 changes from clear to colored. The pattern is designed to provide contrasting colors when the contact lens is removed from the eye.

The thermochromic coating 20 should not interfere with any oxygen transfer within the eye. The thermochromic coating 20 should not be drying, so that the eye can maintain the normal and appropriate levels of moisture. Additionally, the thermochromic coating 20 should be hypoallergenic and not cause any type of eye irritations. The thermochromic coating 20 should be suitable for use within the body and not cause any adverse reactions.

Substrates suitable for use in the preparation of the thermochromic contact lens 10 of the present invention can include any of the plastic optical substrates known in the art and can include non-plastic substrates such as glass. U.S. Pat. No. 7,911,676 teaches a contact lens with photochromic coating applied and is hereby incorporated by reference. Specifically, the '676 patent teaches that “suitable examples of plastic optical substrates, can include polyol(allyl carbonate) monomers, e.g., allyl diglycol carbonates such as diethylene glycol bis(allyl carbonate), which monomer is sold under the trademark CRIK-39 by PPG Industries, Inc; polyurea-polyurethane (polyurea urethane) polymers, which are prepared, for example, by the reaction of an isocyanate-functional polyurethane prepolymer and a diamine curing agent, a composition for one such polymer being sold under the trademark TRIVEXX by PPG Industries, Inc; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); poly(vinyl acetate); poly(vinyl alcohol); poly(vinyl chloride); poly(vinylidene chloride); polyethylene; polypropylene; polyurethanes; polythiourethanes; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, and polymers prepared by reacting polyfunctional isocyanates with polythiols or polyepisulfide monomers, either homopolymerized or co-and/or terpolymerized with polythiols, polyisocyanates, polyisothiocyanates and optionally ethylenically unsaturated monomers or halogenated aromatic-containing vinyl monomers. Also contemplated are copolymers of such monomers and blends of the described polymers and copolymers with other polymers, e.g., to form interpenetrating network products.”

Further, the substrates may have a protective coating, such as, but not limited to, an abrasion-resistant coating, such as a “hard coat,” on their exterior surfaces. For example, commercially available thermoplastic polycarbonate ophthalmic lens substrates are often sold with an abrasion-resistant coating already applied to its exterior surfaces because these surfaces tend to be readily scratched, abraded or scuffed. An example of such a lens substrate is the GENTEXT™ polycarbonate lens (available from Gentex Optics). Therefore, as used herein the term “substrate” includes a substrate having a protective coating, such as but not limited to an abrasion-resistant coating, on its surface(s).

Still further, the substrates can be transparent or possess a light influencing property. Suitable optical substrates can be untinted, tinted, linearly polarizing, circularly polarizing, elliptically polarizing, photochromic, or tinted-photochromic substrates. As used herein with reference to substrates the term “untinted” means substrates that are essentially free of coloring agent additions (such as, but not limited to, conventional dyes) and have an absorption spectrum for visible radiation that does not vary significantly in response to actinic radiation. Further, with reference to substrates the term “tinted” means substrates that have a coloring agent addition (such as, but not limited to, conventional dyes) and an absorption spectrum for visible radiation that does not vary significantly in response to actinic radiation.”

Known reversible organic thermochromic systems consist of a basic color former such as a leuco dye and an acidic developer such as a phenolic compound. In cold, these components are a dark colored salt and upon heating they dissociate above a certain temperature. On cooling the dark colored salt forms again. Reversibly thermochromic compositions are taught in U.S. Pat. No. 9,039,946 and are incorporated herein by reference.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A thermochromic contact lens comprising:
(a) a contact lens;
(b) a thermally reversible thermochromic material on the contact lens that shifts from a color to colorless at approximately normal human temperature within a human eye.

2. The thermochromic contact lens of claim 1, wherein the thermochromic material is applied to the lens to form a pattern with portions of the pattern of thermochromic material remaining free of thermochromic material and the remaining portions of the pattern including the thermochromic material.

3. The thermochromic contact lens of claim 1, wherein the thermochromic material is applied to the lens to form a pattern with portions of the pattern of thermochromic material comprising thermochromic material that shifts between a first color to colorless and thermochromic material that shifts between a second color to colorless, wherein the first color is visually distinguishable from the second color.
